(19) United States
(12) Patent Application Publication
(10) Pub. No.: US 2024/0203219 A1
(43) Pub. Date: Jun. 20, 2024

(54) OUTDOOR DOORBELL WARNING SYSTEM

(71) Applicant: Primax Electronics Ltd., Taipei (TW)

(72) Inventor: Tsung-Han Li, Taipei (TW)

(21) Appl. No.: 18/112,930

(22) Filed: Feb. 22, 2023

(30) Foreign Application Priority Data
Dec. 16, 2022 (TW) 111148591

(51) Int. Cl. G08B 3/10; G06F 3/16; H04R 1/40; H04R 3/12

(52) U.S. Cl. CPC G08B 3/10; G06F 3/165; H04R 1/403; H04R 3/12; H04R 2420/07; H04R 2430/01

(57) ABSTRACT

An outdoor doorbell warning system includes a millimeter-wave radar unit, a first speaker unit and a control module. The control module is electrically connected with the millimeter-wave radar unit and the first speaker unit. When a person in a detection range of the millimeter-wave radar unit is detected by the millimeter-wave radar unit, the control module drives the first speaker unit to emit a warning sound according to the position information of the person. Furthermore, when the person moves or stays in different warning regions, the loudness levels of the warning sounds received by the outsider person are similar or identical.

### FIELD OF THE INVENTION

The present invention relates to a warning system applied to residential security, and more particularly to a doorbell warning system with an early warning function.

### BACKGROUND OF THE INVENTION

With the advancement of modern science and technology, a smart home appliance system has gradually become the standard equipment of today's home or office. In order to maintain and guarantee the safety of living, most residences, office buildings and business places are usually equipped with smart security systems. The 24-hour monitoring function of the smart security system can avoid illegal intrusion or detect and remove abnormal conditions as early as possible.

However, the conventional smart security system still has some drawbacks. For example, after the outsider's invasion occurs and the alarm device is touched by the outsider, the conventional smart security system will be activated, or the conventional smart security system will notify the police department or the security company. In other words, the conventional smart security system does not have the preventing function or the early warning function.

In order to overcome the drawbacks of the conventional technologies, it is important to provide an improved outdoor doorbell warning system with an early warning function.

### SUMMARY OF THE INVENTION

The present invention provides an outdoor doorbell warning system with an early warning function.

In accordance with an aspect of the present invention, an outdoor doorbell warning system is provided. The outdoor doorbell warning system includes a millimeter-wave radar unit, a first speaker unit and a control module. The millimeter-wave radar unit detects a position of at least one person. The millimeter-wave radar unit has a detection range. In addition, at least two warning regions are defined within the detection range. The at least two warning regions includes a first warning region and a second warning region. The first speaker unit has a function of emitting at least two warning sounds. The at least two warning sounds include a first warning sound and a second warning sound. The control module is electrically connected with the millimeter-wave radar unit and the first speaker unit. When the at least one person is in the second warning region, the control module drives the first speaker unit to emit the second warning sound to the at least one person. When the at least one person is in the first warning region, the control module drives the first speaker unit to emit the first warning sound to the at least one person. Furthermore, a loudness of the first warning sound received by the at least one person in the first warning region and a loudness of the second warning sound received by the at least one person in the second warning region are similar or identical.

In an embodiment, the outdoor doorbell warning system further includes an ambient sound detection unit, and the ambient sound detection unit detects an outdoor noise.

In an embodiment, the control module is electrically connected with the ambient sound detection unit, and the control module adjusts intensities of the at least two warning sounds according to an information about the outdoor noise.

In an embodiment, the outdoor doorbell warning system further includes a second speaker unit. The second speaker unit is installed in an indoor area. The second speaker unit has a function of emitting a prompt sound.

In an embodiment, the control module is electrically connected with the second speaker unit. When the millimeter-wave radar unit detects the at least one person, the control module drives the second speaker unit to emit the prompt sound.

In an embodiment, the detection range further includes a third warning region, and the first speaker further emits a third warning sound. When the at least one person is in the third warning region, the control module drives the first speaker unit to emit the third warning sound to the at least one person. Furthermore, the loudness of the second warning sound received by the at least one person in the second warning region and a loudness of the third warning sound received by the at least one person in the third warning region are similar or identical.

In an embodiment, an enabling mode of the first speaker unit corresponds to at least one of the at least two warning regions.

In an embodiment, an enabling mode of the second speaker unit corresponds to at least one of the at least two warning regions.

In an embodiment, the outdoor doorbell warning system further includes a wireless transmission unit, and the wireless transmission unit is connected with a portable electronic device.

In an embodiment, a mobile application is installed in the portable electronic device. An enabling mode and a disabling mode of the first speaker unit are set through the mobile application.

From the above descriptions, the present invention provides the outdoor doorbell warning system. The outdoor doorbell warning system is equipped with the millimeter-wave radar unit for detecting the outside person. In addition, the outdoor doorbell warning system is equipped with the speaker unit to emit a warning sound to warn or deter the outside person. Consequently, the outdoor doorbell warning system has the early warning function. Furthermore, the detection result of the millimeter-wave radar unit is not affected by temperature, color and light fluctuations, and the millimeter-wave radar unit has strong penetrating ability. Consequently, even if the outdoor doorbell warning system of the present invention is used in a harsh weather environment with heavy fog, heavy snow, heavy rain or glare for example, the outdoor doorbell warning system can be operated normally.

Furthermore, the millimeter-wave radar unit detects the distance, the angle and the moving speed of the outside person. According to the detection information about the detection result of the millimeter-wave radar unit, the control module adjusts the intensities of at least two warning sounds. When the outside person moves or stays in different warning regions, the loudness levels of the warning sounds received by the outsider person are similar or identical. Consequently, if the outside person is far away from the millimeter-wave radar unit, the warning sound emitted by the speaker unit can still warn or deter the outside person. If the outside person is close to the millimeter-wave radar unit, warning sound emitted by the speaker unit will not make the person feel uncomfortable. In other words, the technologies of the present invention are industrially valuable.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of an outdoor doorbell warning system according to a first embodiment of the present invention;

FIG. 2A schematically illustrates the detection range of the millimeter-wave radar unit of the outdoor doorbell warning system according to the first embodiment of the present invention;

FIG. 2B schematically illustrates a usage scenario of the outdoor doorbell warning system according to the first embodiment of the present invention;

FIG. 3 schematically illustrates another usage scenario of the outdoor doorbell warning system according to the first embodiment of the present invention; and

FIG. 4 is a schematic functional block diagram illustrating the architecture of an outdoor doorbell warning system according to a second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

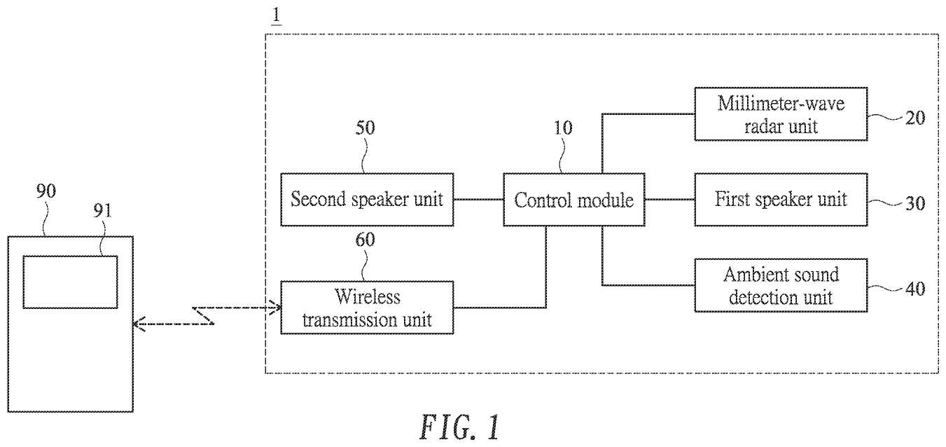

Please refer to FIG. 1. FIG. 1 is a schematic functional block diagram illustrating the architecture of an outdoor doorbell warning system according to a first embodiment of the present invention. The outdoor doorbell warning system 1 can be installed in a security system of a residence or connected with the security system of the residence. As shown in FIG. 1, the outdoor doorbell warning system 1 comprises a control module 10, a millimeter-wave radar unit 20, a first speaker unit 30, an ambient sound detection unit 40, a second speaker unit 50 and a wireless transmission unit 60.

The control module 10 is electrically connected with the millimeter-wave radar unit 20, the first speaker unit 30, the ambient sound detection unit 40, the second speaker unit 50 and the wireless transmission unit 60. The millimeter-wave radar unit 20, the first speaker unit 30 and the ambient sound detection unit 40 are installed in an outdoor area. The second speaker unit 50 is installed in an indoor area.

The wireless transmission unit 60 is in wireless connection with a portable electronic device 90. Moreover, the portable electronic device 90 comprises an operation interface 91. The user can operate the operation interface 91 to control the operation modes of the first speaker unit 30 and the second speaker unit 50. For example, the operation mode of the first speaker unit 30 or the second speaker unit 50 can be selectively set as an enabling mode or a disabling mode through the operation interface 91 of the portable electronic device 90. Preferably but not exclusively, the wireless transmission unit 60 is a radio frequency (RF) wireless transmission unit, a Bluetooth wireless transmission unit, a ZigBee wireless transmission unit or a Wi-Fi wireless transmission unit. In addition, the portable electronic device 90 is a smart phone or a smart watch, and the operation interface 91 is a mobile application (App).

The millimeter-wave radar unit 20 is used to detect whether a person is approaching the residence. In addition, the millimeter-wave radar unit 20 detects the distance, the angle and the moving speed of the approaching person. According to the position information about the person detected by the millimeter-wave radar unit 20, the control module 10 drives the first speaker unit 30 to emit warning sounds with different intensities toward the approaching person. Consequently, when the outsiders stay or move in different distance ranges, they can receive warning sounds with similar or identical loudness.

In an embodiment, the warning sound is a voice message. For example, the voice message contains the information about “video surveillance is on” or “security system is on”. In another embodiment, the warning sound is a high-frequency warning sound. In case that the outdoor doorbell warning system 1 is installed in a special place (e.g., a commodity sales shop or a shopping mall), the user may previously record a prompt voice as the warning sound through the operation interface 91. For example, the prompt voice contains the information about “Welcome”.

Furthermore, if a person approaching or staying in the outdoor area is detected by the millimeter-wave radar unit 20, the control module 10 also drives the second speaker unit 50 to emit a prompt sound to prompt the indoor residents that an outside person is approaching or invading the residence. Preferably but not exclusively, the second speaker unit 50 is a mechanical doorbell, a digital doorbell or any other appropriate doorbell with a wireless transmission function.

The ambient sound detection unit 40 is used for detecting the outdoor noise. For example, the outdoor noise includes the rain sound, the horn sound of the passing vehicle or the firecracker sound. According to the information about the outdoor noise detected by the ambient sound detection unit 40, the control module 10 further adjusts the intensity of the warning sound emitted by the first speaker unit 30. For example, if it rains heavily outdoors, the warning sound emitted by the first speaker unit 30 may be covered up by the sound of rain. Under this circumstance, the DC current flowing through the first speaker unit 30 is increased under control of the control module 10. Consequently, the intensity (e.g., decibel level) of the warning sound emitted by the first speaker unit 30 is increased. In some other embodiments, the ambient sound detection unit 40 is used for monitoring the emergency event. For example, the emergency event includes a smoke alarm, a carbon monoxide alarm, a broken glass sound or a dog barking sound. If the control module 10 judges that the emergency event is generated according to the monitoring result of the ambient sound detection unit 40, the control module 10 drives the second speaker unit 50 to emit a prompt sound to prompt the indoor residents, or the control module 10 transmit a warning message to the portable electronic device 90 to notify the user of the portable electronic device 90 that an emergency even is being generated at this time.

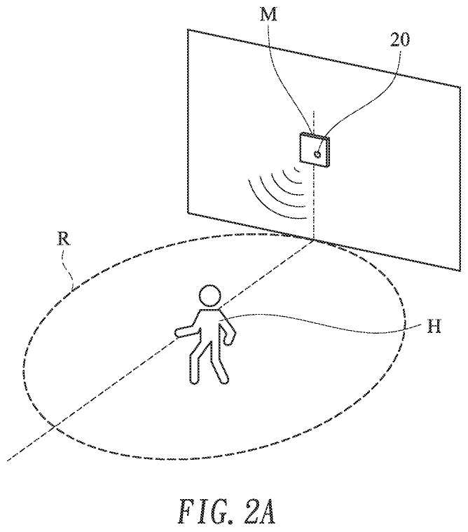

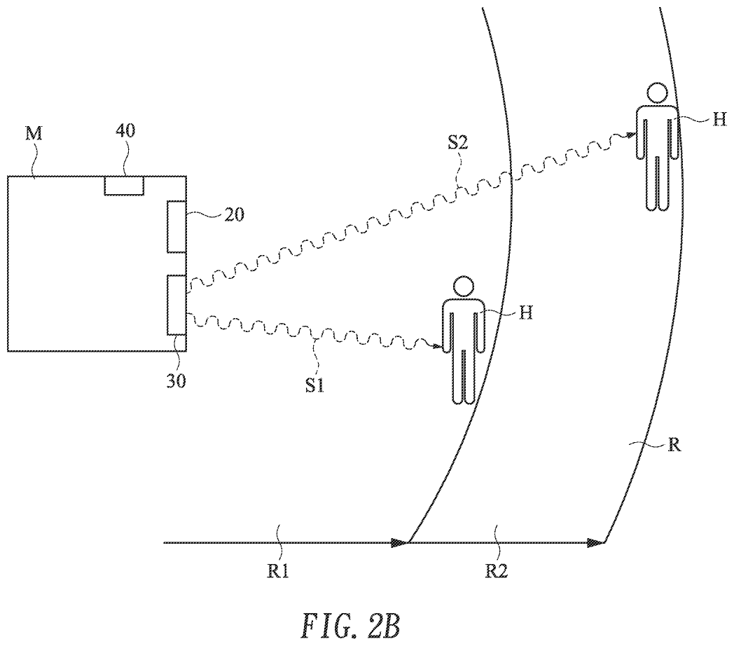

Please refer to FIGS. 1, 2A and 2B. FIG. 2A schematically illustrates the detection range of the millimeter-wave radar unit of the outdoor doorbell warning system according to the first embodiment of the present invention. FIG. 2B schematically illustrates a usage scenario of the outdoor doorbell warning system according to the first embodiment of the present invention.

As shown in FIG. 2A, the millimeter-wave radar unit 20 is installed on an outdoor mailbox M. The millimeter-wave radar unit 20 has a detection range R. When an outside person H (i.e., a person in the outdoor area) appears in the detection range R, the millimeter-wave radar unit 20 can detect that the outside person H appears. In addition, the millimeter-wave radar unit 20 detects the distance, the angle and the moving speed of the outside person relative to the millimeter-wave radar unit 20. Furthermore, when the outside person H appears in the detection range R, the detection information about the detection result of the millimeter-wave radar unit 20 is transmitted from the control module 10 to the portable electronic device 90 through the wireless transmission unit 60, and a sound prompt message or an image prompt message is shown on the operation interface 91. By operating the operation interface 91, the user can determine whether the first speaker unit 30 is driven to emit the warning sound or the prompt voice that is previously recorded as the warning sound.

As shown in FIG. 2B, the millimeter-wave radar unit 20, the first speaker unit 30 and the ambient sound detection unit 40 are all installed on the outdoor mailbox M. In an embodiment, a first warning region R1 and a second warning region R2 are defined within the detection range R of the millimeter-wave radar unit 20. The first warning region R1 is closer to the millimeter-wave radar unit 20 than the second warning region R2. When the outside person H enters the second warning region R2, the control module 10 drives the first speaker unit 30 to emit a second warning sound S2 to the outside person H. When the outside person H moves from the second warning region R2 to the first warning region R1, the control module 10 drives the first speaker unit 30 to emit a first warning sound S1 to the outside person H. In this embodiment, the intensity (e.g., decibel level) of the first warning sound S1 is lower than the intensity (e.g., decibel level) of the second warning sound S2. Consequently, the loudness of the second warning sound S2 received by the outside person H in the second warning region R2 and the loudness of the first warning sound S1 received by the outside person H in the first warning region R1 are similar or identical.

Furthermore, according to the applied place of the outdoor doorbell warning system 1, the enabling mode of the first speaker unit 30 and the corresponding warning region (i.e., at least one of the first warning region R1 and the second warning region R2) are set by the user through the operation interface 91 of the portable electronic device 90.

For example, in case that the outdoor doorbell warning system 1 is located at a larger place, the first speaker unit 30 corresponding to both of the first warning region R1 and the second warning region R2 is in the enabling mode, or the first speaker unit 30 corresponding to the second warning region R2 is in the enabling mode. Consequently, when the outside person H enters the second warning region R2, the control module 10 drives the first speaker unit 30 to emit the second warning sound S2 to the outside person H. Whereas, in case that the outdoor doorbell warning system 1 is located at a smaller place, only the first speaker unit 30 corresponding to the first warning region R1 is in the enabling mode. Consequently, when the outside person H enters the second warning region R2, the control module 10 does not drive the first speaker unit 30 to emit the second warning sound S2 to the outside person H. When the outside person H moves from the second warning region R2 to the first warning region R1, the control module 10 drives the first speaker unit 30 to emit the first warning sound S1 to the outside person H. In some embodiments, the enabling mode of the first speaker unit 30 and the corresponding warning region are pre-defined by the system. That is, it is not necessary to set the enabling mode of the first speaker unit 30 and the corresponding warning region through the operation interface 91 of the portable electronic device 90.

Similarly, the enabling mode of the second speaker unit 50 and the corresponding warning region (i.e., at least one of the first warning region R1 and the second warning region R2) are set by the user through the operation interface 91 of the portable electronic device 90. In an embodiment, the second speaker unit 50 is not enabled when the outside person H enters the second warning region R2, and the control module 10 drives the second speaker unit 50 to emit the prompt sound when the outside person H moves from the second warning region R2 to the first warning region R1. In some embodiments, the enabling mode of the second speaker unit 50 and the corresponding warning region are pre-defined by the system. That is, it is not necessary to set the enabling mode of the second speaker unit 50 and the corresponding warning region through the operation interface 91 of the portable electronic device 90.

At the same time, the ambient sound detection unit 40 detects the outdoor noise. According to the information about the outdoor noise detected by the ambient sound detection unit 40, the control module 10 further adjusts the intensities of the first warning sound S1 and the second warning sound S2 emitted by the first speaker unit 30.

In the above embodiment, the millimeter-wave radar unit 20, the first speaker unit 30 and the ambient sound detection unit 40 are installed on the outdoor mailbox M. It is noted that the installation positions of these components are not restricted. For example, in some other embodiments, the millimeter-wave radar unit 20, the first speaker unit 30 and the ambient sound detection unit 40 are collaboratively or separately installed on an outdoor intercom device, an outdoor lighting system, or any other appropriate building that is able to detect the outside person and emits the warning sound to the outside person.

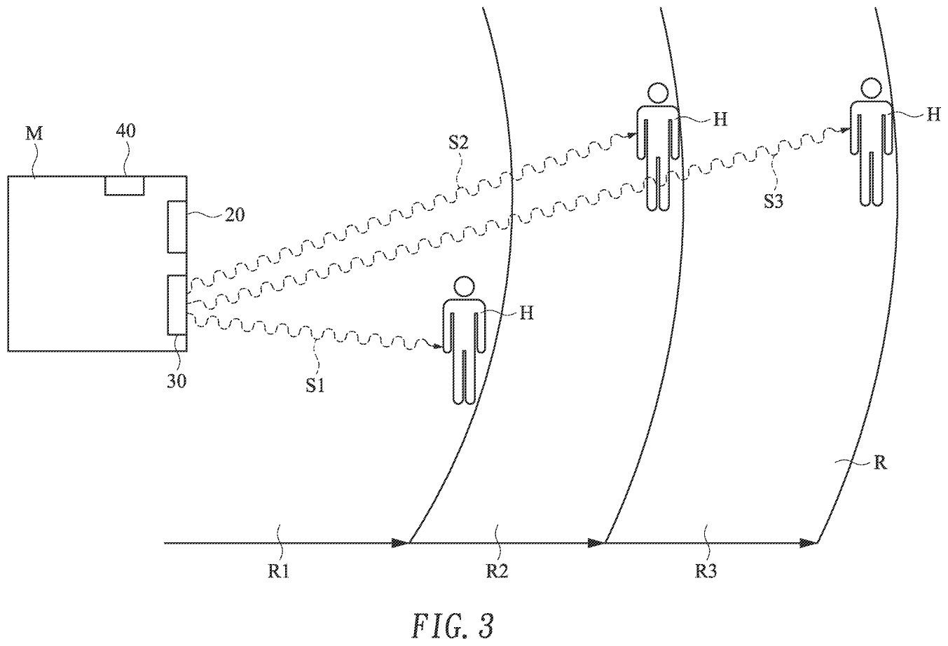

Please refer to FIGS. 1 and 3. FIG. 3 schematically illustrates another usage scenario of the outdoor doorbell warning system according to the first embodiment of the present invention. The operations of the outdoor doorbell warning system in this embodiment are similar to those of FIG. 2B. In comparison with the usage scenario of FIG. 2B, the first warning region R1, the second warning region R2 and a third warning region R3 are defined within the detection range R of the millimeter-wave radar unit 20. The second warning region R2 is closer to the millimeter-wave radar unit 20 than the third warning region R3. When the outside person H enters the third warning region R3, the control module 10 drives the first speaker unit 30 to emit a third warning sound S3 to the outside person H. In this embodiment, the intensity (e.g., decibel level) of the third warning sound S3 is higher than the intensity (e.g., decibel level) of the second warning sound S2. Consequently, the loudness of the third warning sound S3 received by the outside person H in the third warning region R3 and the loudness of the second warning sound S2 received by the outside person H in the second warning region R2 are similar or identical.

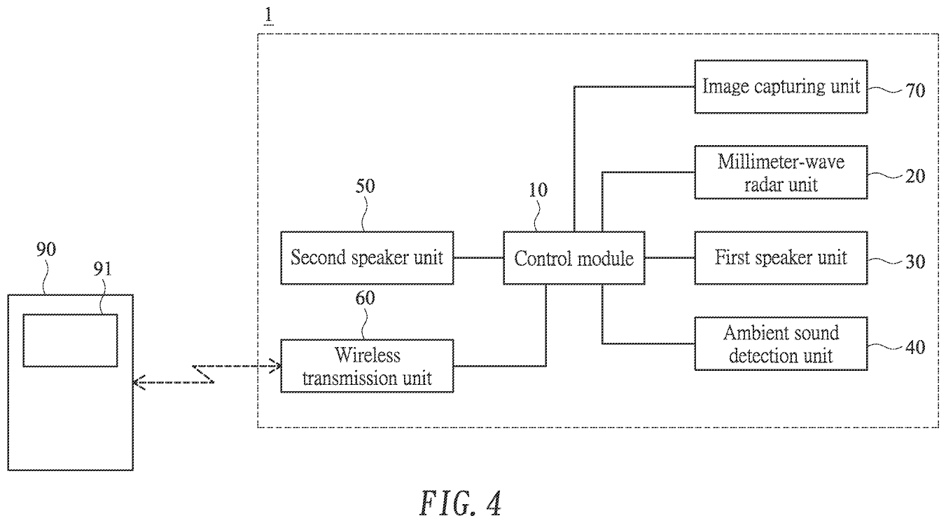

Please refer to FIG. 4. FIG. 4 is a schematic functional block diagram illustrating the architecture of an outdoor doorbell warning system according to a second embodiment of the present invention. In comparison with the first embodiment of FIG. 1, the outdoor doorbell warning system 1 of this embodiment further comprises an image capturing unit 70. The other components of the outdoor doorbell warning system 1 of this embodiment are similar to those of the first embodiment, and not redundantly described herein. In this embodiment, the control unit 10 is further electrically connected with the image capturing unit 70, and the image capturing unit 70 is installed in the outdoor area. The image capturing unit 70 is used to capture images. The information about the captured images can be transmitted from the control module 10 to the portable electronic device 90 through the wireless transmission unit 60. In addition, the information about the captured images can be displayed or prompted on the operation interface 91 of the portable electronic device 90. By viewing the image information displayed on the operation interface 91, the user can operate the operation interface 91 and determine whether the first speaker unit 30 is driven to emit the warning sound or the prompt voice that is previously recorded as the warning sound.

From the above descriptions, the present invention provides the outdoor doorbell warning system. The outdoor doorbell warning system is equipped with the millimeter-wave radar unit for detecting the outside person. In addition, the outdoor doorbell warning system is equipped with the speaker unit to emit a warning sound to warn or deter the outside person. Consequently, the outdoor doorbell warning system has the early warning function. Furthermore, the detection result of the millimeter-wave radar unit is not affected by temperature, color and light fluctuations, and the millimeter-wave radar unit has strong penetrating ability. Consequently, even if the outdoor doorbell warning system of the present invention is used in a harsh weather environment with heavy fog, heavy snow, heavy rain or glare for example, the outdoor doorbell warning system can be operated normally.

Furthermore, the millimeter-wave radar unit detects the distance, the angle and the moving speed of the outside person. According to the detection information about the detection result of the millimeter-wave radar unit, the control module adjusts the intensities of at least two warning sounds. When the outside person moves or stays in different warning regions, the loudness levels of the warning sounds received by the outsider person are similar or identical. Consequently, if the outside person is far away from the millimeter-wave radar unit, the warning sound emitted by the speaker unit can still warn or deter the outside person. If the outside person is close to the millimeter-wave radar unit, warning sound emitted by the speaker unit will not make the person feel uncomfortable. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An outdoor doorbell warning system, comprising:
a millimeter-wave radar unit detecting a position of at least one person, wherein the millimeter-wave radar unit has a detection range, and at least two warning regions are defined within the detection range, wherein the at least two warning regions comprises a first warning region and a second warning region;
a first speaker unit having a function of emitting at least two warning sounds, wherein the at least two warning sounds comprise a first warning sound and a second warning sound; and
a control module electrically connected with the millimeter-wave radar unit and the first speaker unit, wherein when the at least one person is in the second warning region, the control module drives the first speaker unit to emit the second warning sound to the at least one person, wherein when the at least one person is in the first warning region, the control module drives the first speaker unit to emit the first warning sound to the at least one person,
wherein a loudness of the first warning sound received by the at least one person in the first warning region and a loudness of the second warning sound received by the at least one person in the second warning region are similar or identical.

2. The outdoor doorbell warning system according to claim 1, wherein the outdoor doorbell warning system further comprises an ambient sound detection unit, and the ambient sound detection unit detects an outdoor noise.

3. The outdoor doorbell warning system according to claim 2, wherein the control module is electrically connected with the ambient sound detection unit, and the control module adjusts intensities of the at least two warning sounds according to an information about the outdoor noise.

4. The outdoor doorbell warning system according to claim 1, wherein the outdoor doorbell warning system further comprises a second speaker unit, wherein the second speaker unit is installed in an indoor area, and the second speaker unit has a function of emitting a prompt sound.

5. The outdoor doorbell warning system according to claim 4, wherein the control module is electrically connected with the second speaker unit, wherein when the millimeter-wave radar unit detects the at least one person, the control module drives the second speaker unit to emit the prompt sound.

6. The outdoor doorbell warning system according to claim 1, wherein the detection range further comprises a third warning region, and the first speaker further emits a third warning sound, wherein when the at least one person is in the third warning region, the control module drives the first speaker unit to emit the third warning sound to the at least one person, wherein the loudness of the second warning sound received by the at least one person in the second warning region and a loudness of the third warning sound received by the at least one person in the third warning region are similar or identical.

7. The outdoor doorbell warning system according to claim 1, wherein an enabling mode of the first speaker unit corresponds to at least one of the at least two warning regions.

8. The outdoor doorbell warning system according to claim 4, wherein an enabling mode of the second speaker unit corresponds to at least one of the at least two warning regions.

9. The outdoor doorbell warning system according to claim 1, wherein the outdoor doorbell warning system further comprises a wireless transmission unit, and the wireless transmission unit is connected with a portable electronic device.

10. The outdoor doorbell warning system according to claim 9, wherein a mobile application is installed in the portable electronic device, wherein an enabling mode and a disabling mode of the first speaker unit are set through the mobile application.
